(19) United States
(12) Patent Application Publication
(10) Pub. No.: US 2007/0143593 A1
(43) Pub. Date: Jun. 21, 2007

(54) ENCRYPTED KEYBOARD

(76) Inventor: David Alexander Cardoso, London (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/612,279

(22) Filed: Dec. 18, 2006

Related U.S. Application Data
(60) Provisional application No. 60/751,996, filed on Dec. 21, 2005.

(51) Int. Cl. H04L 9/00

(52) U.S. Cl. 713/150

(57) ABSTRACT

A secure input system and method are provided for protecting data transmitted between an input device such as a keyboard and a destination device such as a personal computer (PC). A first secure module is used for intercepting data transmitted by the keyboard to the PC, and the first secure module operates on the data to produce a protected output. A second secure module is used for receiving the protected output from the first secure module and returning the protected output to its original form. The original form of the data may then be forwarded by the second secure module to the PC for use thereby. The system enables a secure communication channel between the keyboard and the PC without requiring additional drivers or software to configure the PC to accept such protected data.

This application claims priority from U.S. application No. 60/751,996 filed on Dec. 21, 2005.

### FIELD OF THE INVENTION

The present invention relates to methods and apparatus for the secure transmission of data from an input device to a destination device.

### DESCRIPTION OF THE PRIOR ART

Data, particularly sensitive data, that is transmitted from an input device such as a keyboard, to a destination port on a computing device such as a personal computers may be susceptible to interception by an adversary using a device such as a hardware key logger.

A key logger may be used by such an adversary to intercept keystrokes, prior to receipt of the keystrokes by an application running at a destination device (e.g. a software program running on a personal computer). A key logger is a device that may be manually attached to a peripheral port and is generally undetectable by software and has non-volatile memory. In general, a key logger is meant to intercept information entering the peripheral port, log the information in its memory, and then pass the unaltered information to the computer port.

The keystrokes that would typically be of interest to an adversary comprise sensitive information such as a password. By intercepting the keystrokes made by the user for entering their password, the adversary may be able use this knowledge to obtain access to a secure location that is protected by the password.

Since passwords are typically stored in memory in an altered form by first undergoing a cryptographic operation such as a hash function, an adversary is unlikely to be able to derive the password from the stored, encrypted version of the password. However, keystrokes sent from an input device to a computing device comprise the original data, e.g., the actual password. Therefore, the data corresponding to these keystrokes that travel from the input device to the particular application, through the peripheral port, are likely susceptible to interception along that path.

To protect an input device from interception by an adversary, various secure keyboard communication systems have been developed. These systems protect the data entered at the input device along its path to the computing device. However, these systems often require unique programming or additional drivers, to initiate and execute such protective measures.

Accordingly, computing devices that are protected by such secure keyboard systems require reconfiguration and or the installation of custom software or additional drivers, which is generally undesirable for not only home computers but also those used in business and commercial applications. Examples of such secure keyboard communication systems are shown in U.S. Pat. No. 6,049,790 to Rhelimi; U.S. Pat. No. 5,748,888 to Angelo et al.; U.S. Pat. No. 5,920,730 to Vincent; U.S. Pat. No. 6,134,661 to Topp; and U.S. Pat. No. 5,832,214 to Kikinis; and U.S. Publication Nos. 2004/0230805 to Peinado; and 2003/0159053 to Fauble et al.

A secure input system, particularly for protecting keyboard inputs, is needed that requires minimal modification to the components being protected.

It is therefore an object of the present invention to obviate or mitigate at least one of the above-identified disadvantages.

### SUMMARY OF THE INVENTION

A system and method are provided for securing data between an input device and a destination device without the need for additional software or drivers to accommodate such secure transmission.

In one aspect, a secure input system is provided for protecting data transmitted between an input device and a destination device. The system comprises a first secure module for intercepting data transmitted by the input device, the first secure module operating on the data to produce a protected output; and a second secure module for receiving the protected output from the first secure module and returning the protected output to its original form, the original form of the data being forwarded by the second secure module to the destination device for use thereby over a data communication link therebetween.

Preferably, each of the secure modules comprises an encryption function and the protected output comprises an encrypted version of the data transmitted by the input device.

In another aspect, a method for protecting data transmitted between an input device and a destination device is provided. The method comprises the steps of a first secure module intercepting data transmitted by the input device, the first secure module operating on the data to produce a protected output, the first secure module transmitting the protected output to a second secure module, the second secure module receiving the protected output and returning the protected output to its original form, and the second secure module forwarding the original form of the data to the destination device.

In yet another aspect, a secure keyboard is provided for protecting data input thereto. The secure keyboard comprises a keypad for accepting keystrokes; a controller for translating the keystrokes to electrical signals and transmitting the electrical signals to a destination device. and a secure transmission module for intercepting data transmitted by the controller, the transmission module operating on the electrical signals to produce a protected output; wherein the protected output is sent by the transmission module to a secure receiving module interposed between the secure keyboard and the destination device, the receiving module capable of operating on the protected data to obtain the electrical signals for use by the destination device.

In yet another aspect, a module is provided for handling protected data sent from a secure input device, the module being interposed between the input device and an intended destination. The module comprises an input for receiving the protected data from the input device; a secure function for converting the protected data back to its original form, the secure function being compatible with a function used by the input device to obtain the protected data; and an output for transmitting the original form of the protected data to the intended destination.

### BRIEF DESCRIPTION OF THE DRAWINGS

An embodiment of the invention will now be described by way of example only with reference to the appended drawings wherein:

FIG. 1 is a schematic of a secure input system;

FIG. 2 is a flow chart showing a method of securing communication between an input device and a destination device, and

FIG. 3 is a partial schematic of another embodiment of a secure input system.

### DETAILED DESCRIPTION OF THE INVENTION

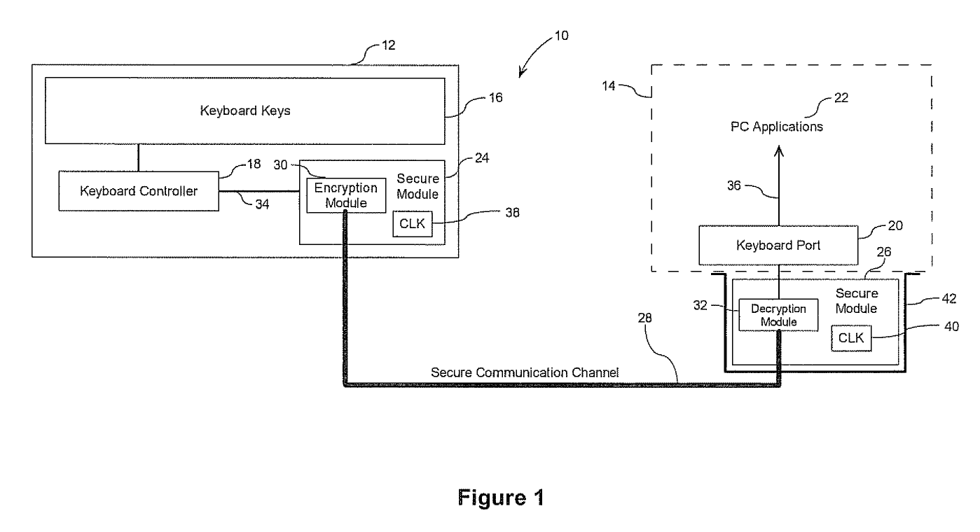

Referring therefore to FIG. 1, a secure input system is generally denoted by numeral 10. The system 10, in this example, is implemented for securing data that is transmitted between a keyboard 12 (an input device) and a personal computer (PC) 14 (a destination device). The keyboard 12 comprises a set of input keys 16 and a keyboard controller 18 for translating keystrokes to electronic signals such as USB or PS/2 code, that can be transmitted to the PC 14. The PC 14 comprises a port 20 for receiving data transmitted by the keyboard 12, and various applications 22 running thereon that may use the data entered using the keyboard 12.

Interposed between the keyboard controller 18 and the PC Port 20 is a first secure module 24 implemented as part of the keyboard 12, and a second secure module 26 attached to the PC 14, that are interconnected by a data link, in this example, a secure communication channel 28. The secure channel 28 is used to securely transmit protected data thereover, and may comprise a cable or wireless data link. In this example, the module 24 comprises an encryption module 30 for encrypting data transmitted by the keyboard controller 18, and the module 26 comprises a decryption module 32 for decrypting the protected data transmitted by the module 24.

The modules 24 and 26 are preferably implemented using printed circuit boards, and the modules 30 and 32 are preferably implemented with microcontrollers, such as PIC 18F252 devices available from Microchip™. In this example, the modules 24 and 26 have clocks 38 and 40 respectively for synchronizing the timing of data transmitted between the modules 30 and 32. Preferably, the clocks 38 and 40 are 16 MHz crystal clocks. As indicated above, in this example, the module 26 is attached to the PC 14. Preferably, the module 26 is fastened to the rear metal casing of the PC 14, and has a protective covering 42 surrounding it, to inhibit a key logger from being inserted into the keyboard port 20.

The encryption module 30 is preferably programmed with an encryption algorithm in order to encrypt data intercepted thereby, and the decryption module 32 is preferably programmed with a decryption algorithm to decrypt data received from the encryption module 30, in order to reverse the encryption operation and return the data to its original form. Preferably, the encryption and decryption algorithms use rolling key encryption.

Rolling key encryption uses a non-static “rolling” key. For example, a 16 byte key may be first hard coded into the microcontrollers 30 and 32 when manufactured. In such an example, upon each transmission from the keyboard 12 to the PC 14, the current key would be altered, and this altered key would then be added to the data sent by the keyboard controller 18. When the encrypted data is received by the module 32, the same altered key value may then be subtracted from tile transmitted data, to obtain the original data.

If rolling key encryption is used, the clocks 38 and 40 would preferably store the current keys (e.g. using key counters) and would be used to ensure that the keys do not become out of sync. The key counters in the clocks 38 and 40 may be reset at power on to perform a re-synchronization. In such an implementation, since the key is always changing, it makes it difficult for an adversary to train a “sniffer” to derive the encryption key.

It will be appreciated that any suitable encryption algorithm may be used, such as the 168 bit triple data encryption standard (3DES), depending on the application and availability of the desired technology.

The module 24 is connected to the controller 18 by connection 34, and the module 26 connects to the PC application 22 through the port 20, by connection 36. In the arrangement shown in FIG. 1, data sent over connection 34 may be considered to be in its normal, original form and thus “in the clear”, data sent over connection 28 may be considered “protected”, and data sent over connection 36 may also be considered to be in its normal, original form and thus “in the clear”.

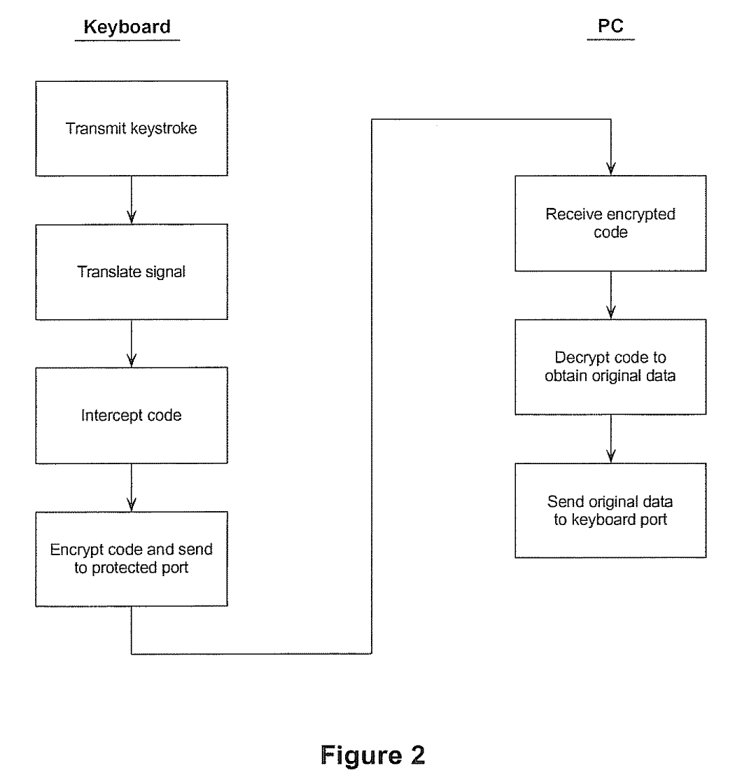

Referring to FIG. 2, an exemplary method for transmitting data using the system 10 of FIG. 1 is illustrated. The following will discuss the transmission of a single keystroke from the keyboard 12, as an input to the PC 14 for use by application 22. It will be appreciated that principles outlined below are applicable to other input devices for use with other destination devices, and that the preferred implementation outlined herein is used for illustrative purposes only.

A keystroke applied to one of the keyboard keys 16 produces an electrical signal that is transmitted to the keyboard controller 18. The controller 18 translates the electrical signal into a code, e.g. USB, PS/2, RS232, proprietary, etc., and transmits same with the intention that the code is received by the keyboard port 20 and then used as an input for the application 22. In this example, the secure module 24 intercepts the code, and using the encryption module 30, modifies the code by applying its encryption algorithm thereto, producing an encrypted output. In this example, the current key stored in the key counter of the clock 38 would be added to the data to obtain the encrypted output.

The encrypted output would then be sent to the secure module 26, where it would be input to the decryption module 32, and returned to its original state, namely to that which was originally transmitted by the keyboard controller 18. In this example, the decryption operation would operate by subtracting the current key from the data received from module 30. The original data is then transmitted to the keyboard port 20. The data may then be used by the PC application 22 currently running on the PC 14 as an input or other command.

Since the modules 24 and 26 are interposed between the keyboard controller 18 and the keyboard port 20, and since the code transmitted by the controller 18 is intercepted by the module 24, the keyboard controller 18 believes it is communicating with the keyboard port 20 and vice versa. Therefore, the secure transmission along channel 28 may occur without the need to re-configure the PC nor provide additional drivers to accommodate the modules 30 and 32.

The data is protected between the modules 30 and 32, and if intercepted along the path 28, will not reveal the actual keystrokes applied to the keys 16. The actual relative positioning of the controller 18 and module 26 and of the module 26 and port 20 are arbitrarily shown in FIG. 1 and may be implemented in any suitable arrangement as desired. For example, the module 24 may be implemented as part of the keyboard controller 18, or may even be attached to the exterior of the keyboard 12.

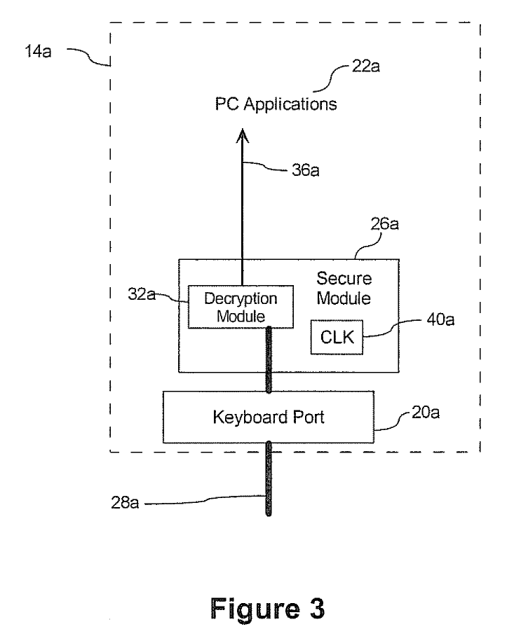

In another arrangement, shown in FIG. 3, the protective cover 42 is not used, and a secure module 26a is contained within the casing of a PC 14a. In the example shown in FIG. 3, like elements are given like numerals with the suffix “a”. Such an arrangement is particularly useful for newly manufactured computers that can be built to incorporate the secure module 26a, and would thus not require any retrofitting.

In the arrangement of FIG. 3, the keyboard port 20a accepts encrypted data from the secure channel 28a. The secure channel 28a preferably originates from a keyboard 12 such as that shown in FIG. 1, wherein the output from the keyboard controller 18 is intercepted by the module 24. Accordingly, in this example, the keyboard port 20a preferably accepts data only from an “encrypted keyboard”, e.g. the keyboard 12 of FIG. 1.

The data received by the port 20a is then passed to the decryption module 32a, where it is decrypted in a manner similar to that described above. The output of the module 26a then represents the data in its original, unencrypted form, and may be provided to the application 22a as desired. In such an arrangement, even if a key logger is attached to the port 20a, it would only be able to log and store encrypted data which is anyhow, of no use to an adversary.

Therefore, the an arrangement shown in FIG. 1 is most suitable for retrofitting an existing PC 14, and the arrangement shown in FIG. 3 is most suitable for implementing the secure input system 10 as part of a new PC 14a. The most preferred implementation is that shown in FIG. 3, since an adversary would be given no indication that the module 26a even exists. However, the arrangement shown in FIG. 1 provides a means to implement the secure input system 10 with an existing PC 14.

It will be appreciated that the system 10 may also be implemented with other devices requiring keyboard input such as an automated teller machine (ATM). It will also be appreciated that the principles outlined above may also be applied to other input devices, and shall not be limited to keyboards and PCs.

Although the invention has been described with reference to certain specific embodiments, various modifications thereof will be apparent to those skilled in the alt without departing firm the spirit and scope of the invention as outlined in the claims appended hereto.

What is claimed is:

1. A secure input system for protecting data transmitted between an input device and a destination device, said system comprising:
a first secure module for intercepting data transmitted by said input device, said first secure module operating on said data to produce a protected output; and
a second secure module for receiving said protected output from said first secure module and returning said protected output to its original form, said original form of said data being forwarded by said second secure module to said destination device for use thereby over a data communication link therebetween.

2. A system according to claim 1 wherein said first secure module comprises an encryption function and said protected output comprises an encrypted version of said data transmitted by said input device, and wherein said second secure module comprises a decryption function for said step of returning said protected output to its original form.

3. A system according to claim 2 wherein said encryption function is a rolling key encryption function.

4. A system according to claim 3 wherein each said secure module updates and stores a current copy of a key for encrypting and decrypting said data.

5. A system according to claim 4 wherein each said secure module comprises a clock for simultaneously updating said key, each said clock storing said current copy.

6. A system according to claim 5 wherein each said clock is reset during power on to resynchronize said key.

7. A system according to claim 5 wherein each said clock is a 16 MHz crystal clock.

8. A system according to claim 2 wherein said encryption function operates according to a 168 bit triple data encryption standard (3DES).

9. A system according to claim 1 where said data communication link is a secure communication channel.

10. A method for protecting data transmitted between an input device and a destination device, said method comprising the steps of:
a first secure module intercepting data transmitted by said input device;
said first secure module operating on said data to produce a protected output;
said first secure module transmitting said protected output to a second secure module;
said second secure module receiving said protected output and returning said protected output to its original form;
said second secure module forwarding said original form of said data to said destination device.

11. A method according to claim 10 wherein said step of operating on said data comprises encrypting said data and said step of returning said protected output to its original form comprises decrypting said protected output.

12. A method according to claim 11 comprising changing a key used in said encrypting and said decrypting according to a rolling key function.

13. A method according to claim 12 comprising storing a current copy of said key.

14. A method according to claim 13 wherein said key is simultaneously updated at each secure module using a respective clock, each said clock storing said current copy.

15. A method according to claim 14 comprising resetting each said clock during power on to resynchronize said key.

16. A method according to claim 11 comprising encrypting said data according to a 128 bit triple data encryption standard (3DES) algorithm.

17. A secure keyboard for protecting data input thereto comprising:
a keypad for accepting keystrokes;
a controller for translating said keystrokes to electrical signals and transmitting said electrical signals to a destination device; and
a secure transmission module for intercepting data transmitted by said controller, said transmission module operating on said electrical signals to produce a protected output;
wherein said protected output is sent by said transmission module to a secure receiving module interposed between said secure keyboard and said destination device, said receiving module capable of operating on said protected data to obtain said electrical signals for use by said destination device.

18. A secure keyboard according to claim 17 wherein said secure transmission module is housed within said keyboard.

19. A secure keyboard according to claim 17 wherein said secure transmission module is securely attached externally to a housing of said secure keyboard.

20. A module for handling protected data sent from a secure input device, said module being interposed between said input device and an intended destination, said module comprising:
an input for receiving said protected data from said input device;
a secure function for converting said protected data back to its original form, said secure function being compatible with a function used by said input device to obtain said protected data; and
an output for transmitting said original form of said protected data to said intended destination.

21. A module according to claim 20 wherein said module is housed within a device at said intended destination.

22. A module according to claim 20 wherein said module is securely attached externally to a housing of a device at said intended destination.
